(19) United States
(12) Patent Application Publication
(10) Pub. No.: US 2015/0262808 A1
(43) Pub. Date: Sep. 17, 2015

(54) Light Source Driven by Laser

(71) Applicant: Weifeng Wang, Rancho Cucamonga, CA (US)

(72) Inventor: Weifeng Wang, Rancho Cucamonga, CA (US)

(21) Appl. No.: 14/215,063

(22) Filed: Mar. 17, 2014

(51) Int. Cl. H01J 65/04; H05H 1/46; H05H 1/48

(52) U.S. Cl. CPC H01J 65/04; H05H 1/48; H05H 1/46

(57) ABSTRACT

A light source includes an enveloped chamber (32) enclosing an ionizable medium (46) and at least one laser source to provide continuous energy to the plasma (64), i.e. the excited and ionized medium, for producing high-brightness light. The envelop (34) prevents the thermal convection on the inner chamber and provides insulation to the heat transferred out of the plasma so as to generate more stable and stronger emission of light. A method for producing enhanced-brightness light includes the using of multiple chamber assemblies (178a and 178b) and at least one laser source (164) to power the plasma within each chamber assembly in sequence. A method for improving the efficiency of laser usage includes a procedure to re-focus the unabsorbed laser beam (270) back to the same plasma (272) so that more laser energy can be absorbed by the plasma to deliver increased light output.

### FIELD OF INVENTION

The present invention relates generally to light sources. More particularly, the invention concerns an apparatus that produces high-brightness light through the excitation of an ionizable medium enclosed in an enveloped chamber, with the excitation energy supplied from one or more external laser sources.

### BACKGROUND OF THE INVENTION

In regular gas discharge light sources, radiation is produced by hot excited gas, normally in an ionized state, which is sustained by the electric field applied to the discharging gas. The electric field usually is created by two oppositely positioned electrodes set at the operating voltage of the light source. In comparison, light sources, driven or powered by laser, use laser energy instead of electric field as the power source to sustain the ionized gas, i.e. plasma. The absorbed laser energy compensates for the thermal and optical energy loss of the plasma, such that continuous light emission can be produced from the plasma. Because in such light sources the photons are usually generated through the deceleration of electrons and the recombination of electrons and ions, their emission spectra can comprise continuum bands according to the principles of plasma physics.

One of the main features of laser-driven light sources is their high-brightness light output ranging in wavelength from infrared to deep ultraviolet. Over the past decade, increasing applications of high-brightness light sources have been observed in a variety of fields including semiconductor wafer fabrication, fluorescent material inspection, photochemical reactions, DNA and RNA concentration measurement, deep UV lithography, atomic absorption spectroscopy and many more.

Prior arts of laser-driven light source were described in U.S. Pat. No. 8,525,138, U.S. Pat. No. 8,309,943 and U.S. Pat. No. 7,786,455 issued to Smith, et al. In these configurations, an infrared laser beam generated by a diode laser is directed down an optical fiber cable to a convex lens that focuses the laser beam onto the high-density gas, for example Xe, within a single-wall chamber. Due to the absorption of the converged laser energy, the gas at the focal point can reach such a high temperature of over 10,000K that strong atomic excitation and ionization processes can take place. Thereby, bright light can be produced from the plasma gas with a typical small size of 100 μm.

The metal-type ionizable mediums such as mercury are tackled by U.S. Pat. No. 8,242,695 issued to Sumitomo, et al. A method is disclosed therein to effectively vaporize the metals that usually are in the state of solid or liquid. The idea is to reflect a portion of laser radiation, which is not absorbed by the plasma, back into the chamber. Thus, the cold-spot temperature on the chamber wall can be increased. The higher cold-spot temperature is beneficial to the vaporization of the metal mediums.

However, in all the published prior arts, a single-wall chamber enclosing an ionizable medium was used. Consequently, thermal convection of air takes place on the outer surface of the chamber wall and substantially affects the thermal balance of the hot plasma inside the chamber. Besides, the single-wall chamber does not provide sufficient insulation for the blockage of the heat transferred out of the hot plasma. The resultant disadvantages for the light sources are:
a) Slow warm-up of light source;
b) More drift of light output;
c) More plasma movement;
d) More consumption of laser power.

In another aspect, a great amount of over 60% laser beam traveling through the chamber cannot be absorbed by the ionized medium in the prior arts referenced. The unabsorbed laser energy is so high that it not only means a lot of waste of laser power, but also can easily damage the surrounding parts inside the light-source device. Although the aforementioned U.S. Pat. No. 8,242,695 issued to Sumitomo, et al., proposes to absorb or reflect back part of laser energy with a shield built in the chamber, their design is practically very difficult to be implemented because the shield will work next to the very hot plasma of over 10,000K. Such a hot environment will make the shield material evaporate out more quickly and eventually will lead to the quick blackening of the chamber wall. Hence, premature failure of the light source can be observed due to the blockage of emission light by the dark wall.

### SUMMARY OF THE INVENTION

The object of the present invention is to resolve the above issues in existing laser-driven light sources by providing novel apparatuses and methods to greatly improve the thermal balance inside the chamber, reduce the heat loss of the light source, minimize the waste of laser power and increase the light brightness and the total light output.

In the present invention with regard to laser-driven light source, a new light-transmitting chamber assembly containing one or more ionizable mediums is provided. An envelop is introduced to enclose a chamber that contains one or more ionizable mediums. The envelop and the chamber are made of light-transmitting materials such as quartz, fused quartz, ozone free quartz, synthetic quartz, single crystal quartz, UV blocking quartz, UV transmitting quartz, Suprasil quartz, fused silica, Suprasil fused silica, glass, alumina ceramic, sapphire, diamond, MgF₂, CaF₂ or a compound of them. The space between the envelop and the chamber can be either evacuated to create a vacuum inside or filled with air or any other gas such as Xe, Kr, Ar, Ne, He, N₂, O₂, CO₂, D₂ and H₂, or a mixture of two or more gases at various pressures. Because the added envelop acts as a protective outer chamber to the inner chamber, it can prevent the thermal convection on the surface of the inner chamber and thus reduce the drift of the plasma for improved stability. Meanwhile, the envelop furnishes a good thermal insulation to the heat conducted out of the plasma when the light source is in operation. This thermal insulation will effectively help to maintain the plasma at a higher temperature, which is beneficial for brighter light radiation, quicker warm-up of the light source and less consumption of laser power. In some embodiments, at least one of the envelop and the chamber has a coating that transmits and reflects selective radiation. In some embodiments, there is means for removing the deposit on the chamber window so that laser beam can be transmitted into the chamber without obstruction form the deposit.

In the present invention with regard to laser-driven light source, a new method is provided to reuse the laser energy unabsorbed by a plasma within a chamber to create multiple light-emitting sources. The unabsorbed laser beam is re-focused onto one or more additional chamber assemblies, each having one or more ionizable mediums enclosed in a chamber with or without an envelop. The light radiations emitted from these multiple sources can be utilized independently or can be combined together through an optical-fiber coupler or a multi-branch optical fiber. By way of this method, enhanced light brightness and output can be obtained with minimized waste of laser power and improved safety for the internal parts.

In the present invention with regard to laser-driven light source, a new method is provided to re-focus the unabsorbed laser beam back to the same plasma at the same area inside the chamber. Stronger light emission can be produced since more laser energy is absorbed by the plasma.

### BRIEF DESCRIPTION OF THE DRAWINGS

FIGS. 1A and 1B are a general view of a typical chamber assembly with an envelop according to the present invention.

FIG. 2 is a diagrammatic view of a basic laser-driven light source featuring a chamber assembly with an envelop.

FIGS. 3A, 3B and 3C are the illustrative view of three alternate forms of chamber assembly with an envelop.

FIGS. 4A and 4B are the illustrative views of two additional forms of chamber assembly with an envelop.

FIGS. 5A and 5B are the illustrative views of another two forms of chamber assembly with an envelop.

FIGS. 6A and 6B are the illustrative views of two enveloped-chamber assemblies, each having a built-in reflector.

FIG. 7 is a diagram showing a method for creating multiple light-emitting sources driven by laser.

FIG. 8 is the illustrative view of a laser-driven light source comprising multiple light-emitting sources.

FIG. 9 is the illustrative view of an alternate form of laser-driven light source comprising multiple light-emitting sources.

FIG. 10 is the illustrative view of another form of laser-driven light source comprising multiple light-emitting sources.

FIG. 11 is the illustration of a method for re-focusing unabsorbed laser beam back to the same plasma within an enveloped chamber.

FIG. 12 is the illustration of a method for reducing the size of the laser-beam deflector to deliver more light output.

### DESCRIPTION OF THE INVENTION

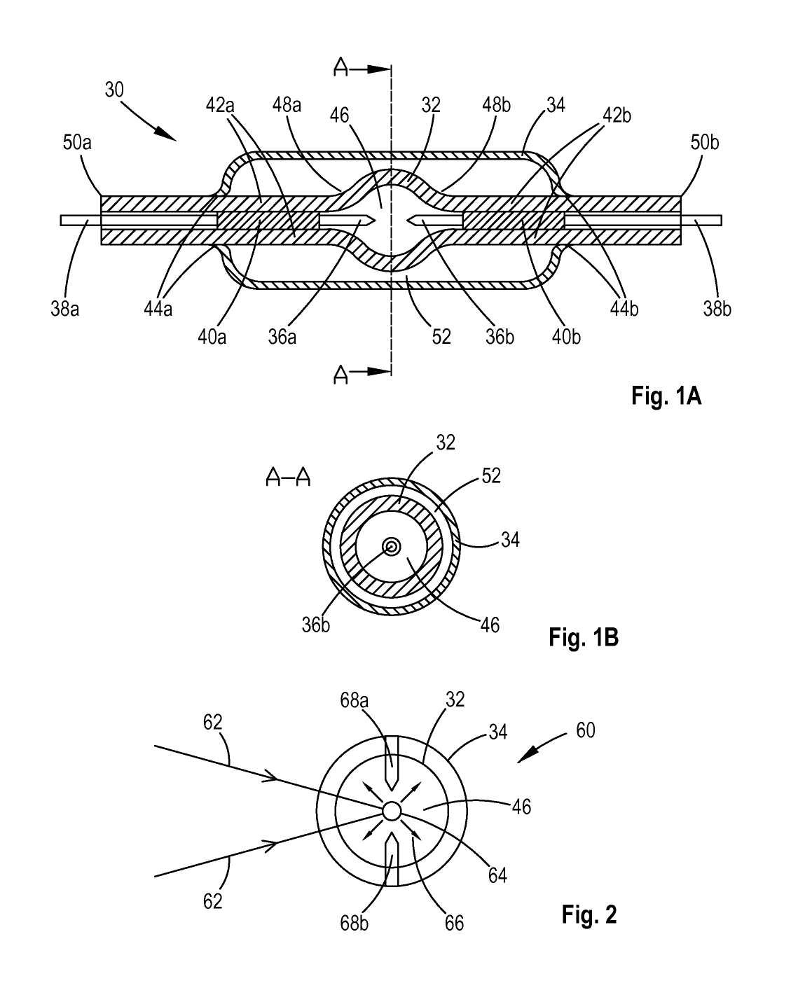

FIG. 1A shows a typical enveloped chamber assembly 30 comprising a gas-tight single-wall chamber 32 which is covered with an envelop 34. A pair of electrodes 36a and 36b are arranged at the opposite positions inside the chamber and are electrically connected to the two conductors 38a and 38b through members 40a and 40b, which are sealed to the walls 42a and 42b respectively of the two tubes adjoining the chamber. The sealing is made by softening the tubes' walls 42a and 42b in the areas with one or more torches and then pressing the walls or letting the walls collapse by themselves toward the members 40a and 40b. The chamber 32 is entirely jacketed with the envelop 34 with a preferential clearance of at least 0.1 mm, although a fraction of 0.1 mm clearance or even no clearance is also allowed. In this embodiment, the two ends of the envelop 34 are shrunk and attached to the tubes at the locations 44a and 44b where the members 40a and 40b meet the conductors 38a and 38b.

Enclosed in the chamber 32 is the ionizable medium 46 that can be one or more of gases such as Xe, Ar, Ne, Kr, He, D₂, H₂, O₂, F₂, air and N₂, or metals such as Hg, Cd, Zn, Sn, Ga, Fe, Li and Na, or excimer forming gases, or chemical compounds such as metal halides, metal oxides and halogens.

Light-transmitting materials used to build the envelop 34 and the chamber 32 as well as the two tubes adjoining the chamber can be selected from quartz, fused quartz, ozone free quartz, synthetic quartz, single crystal quartz, UV blocking quartz and UV transmitting quartz that for example are available from Momentive Performance Materials Inc., Strongsville, Ohio, and Suprasil quartz, fused silica and Suprasil fused silica that for example are available from Heraeus Quartz America LLC, Buford, Ga., and glass (e.g. Corning Inc., Corning, N.Y.), alumina ceramic (e.g. NGK Insulators Ltd., Nagoya, Japan), sapphire, diamond, MgF₂, CaF₂, or a compound of them. The shapes of the envelop and the chamber include a cylindrical and tubular shape, a spherical shape, an elliptical shape, a parabolic shape, an aspheric shape, a curved shape, or a combination of these shapes. The envelop and the chamber can have the same or different shapes, and, the inner surface and the outer surface of the envelop or the chamber can also have the same or different shapes.

Members 40a and 40b have a thermal expansion coefficient close to that of the tubes' walls 42a and 42b. They can be the foils of molybdenum, or the foils of other metals such as tungsten, nickel, tantalum, and rhenium, etc., or a foil of alloys. It is to be noted that the seals made for members 40a, 40b and the tubes walls can also be a graded glass seal, for which each member of 40a and 40b can be a metal rod. In some embodiments, there are direct connections between the electrodes and the conductors without the presence of members 40a and 40b. In some embodiments, each electrode and the conductor are built to one single part, without the use of members 40a and 40b for intermediate connection.

The envelop 34 jacketing the entire chamber 32 can be sealed onto the tubes anywhere from the neck-shape portions 48a and 48b, where the chamber and the tubes join together, to the ends 50a and 50b of the tubes, or can be directly sealed onto the exposed portions of the conductors 38a and 38b. The space 52 between the chamber 32 and the envelop 34 can be evacuated to create a vacuum inside or filled with air or any other gas such as Xe, Kr, Ar, Ne, He, N₂, O₂, CO₂, D₂ and H₂, or a mixture of more than one of gases at various pressures. In some embodiments, one or both ends of the envelop 34 are not gas-tightly sealed to the tubes or to the exposed portions of the conductors.

The electrodes 36a and 36b are used to ignite the ionizable medium, and may optionally supply additional energy to the plasma when the light source is in operation. In some embodiments, the electrodes are disposed side by side in the chamber 32. It is to be understood that the ignition source does not necessarily need to be made with electrodes. In some embodiments, there is no electrode installed inside the chamber and one or more external ignition sources such as a laser, a UV source, a lamp, a capacitive ignition source, an inductive ignition source or a microwave or RF ignition source can be used.

A cross-sectional view of the chamber assembly 30 along the direction A-A as designated in FIG. 1A is shown in FIG. 1B. It needs to be noted that throughout this document, same numerals are used to refer to the same element and character, and their descriptions may be omitted for convenience.

FIG. 2 is the illustration of a basic configuration of laser-driven light source 60 using an enveloped chamber that encloses one or more ionizable mediums. In the present configuration, incident laser beam 62, generated by at least one laser source (not shown) including a pulse or continuous wave laser such as a diode laser, is focused onto a small area inside the chamber 32 which is fully covered with the light-transmitting envelop 34. The high-density ionizable medium 46 such as Xe gas within the chamber is excited and ionized by the converged laser energy at the focal-point area to form the plasma 64 that produces light radiation 66 in all the directions. A pair of electrodes 68a and 68b is disposed as shown to ignite the ionizable medium 46 initially. As indicated earlier, the electrodes can be arranged in other orientations and electrodeless ignition source can be used alternatively. In some embodiments, the wall of the chamber 32 is preheated with one or more external heating sources such as laser before the plasma 64 is established. The preheating laser beam passes through the envelop 34 and irradiates the deposit areas on the chamber wall where materials of electrodes, quartz and substances of the ionizable medium may build up over operation time. The deposited substances will be vaporized with the laser energy such that the follow-on laser for sustaining the plasma can travel into the chamber without obstruction from the deposit. The ionizable medium can be initially excited with the ignition source either before or after the preheating.

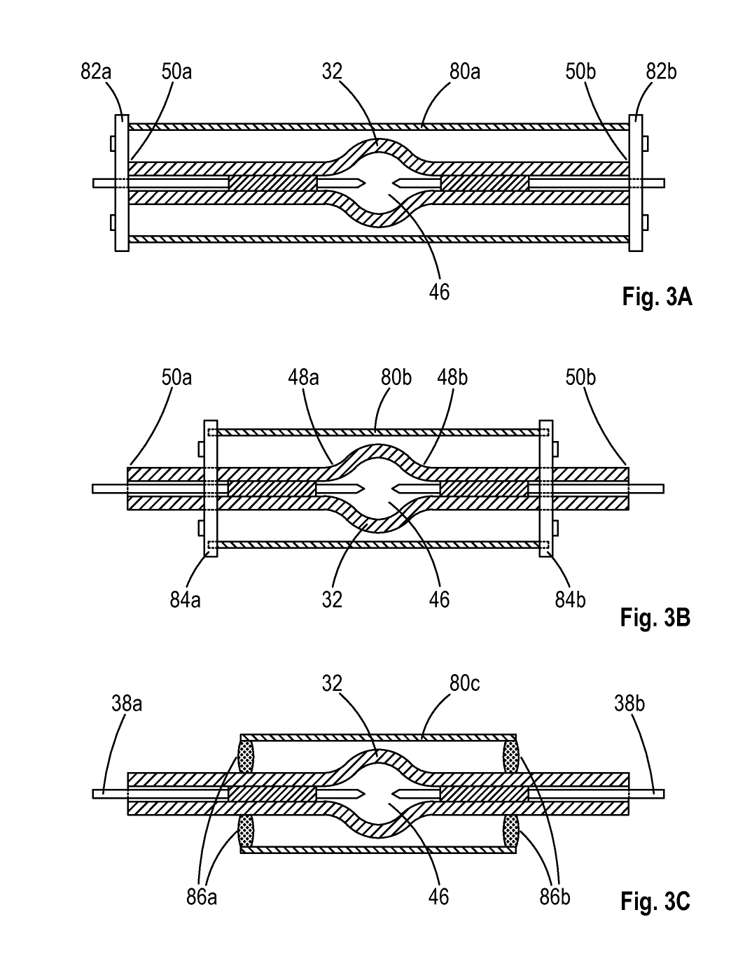

FIGS. 3A, 3B and 3C show the three alternate forms of the chamber assembly, each having an envelop that is designated by 80a, 80b and 80c respectively. In FIG. 3A, the envelop 80a is sealed to the ends 50a and 50b of the tubes through the base mount seals 82a and 82b. In FIG. 3B, it is shown that the base mount seals 84a and 84b can be created anywhere from the neck-shaped portions 48a and 48b to the ends 50a and 50b of the tubes. In FIG. 3C, it is shown that the seals 86a and 86b can be made with chemical bonding materials such as resins, epoxies, adhesive compounds, silicon sealant, cements, UV curing adhesives or glues. There are a few sources of the bonding materials suitable for this purpose. Examples are the clear glass bonder Loctite E-30CL and Devcon Tru-Bond UB 3000 (Ellsworth Adhesives Inc., Germantown, Wis.), and 3M polyurethane adhesive sealant 590 (3M United States, St. Paul, Minn.). In this case, the envelop 80c can be shrunk to make the sealing easier and as in FIG. 3B, the seals 86a and 86b can be created anywhere along the tubes from the neck-shaped portions to the exposed portions of the conductors 38a and 38b.

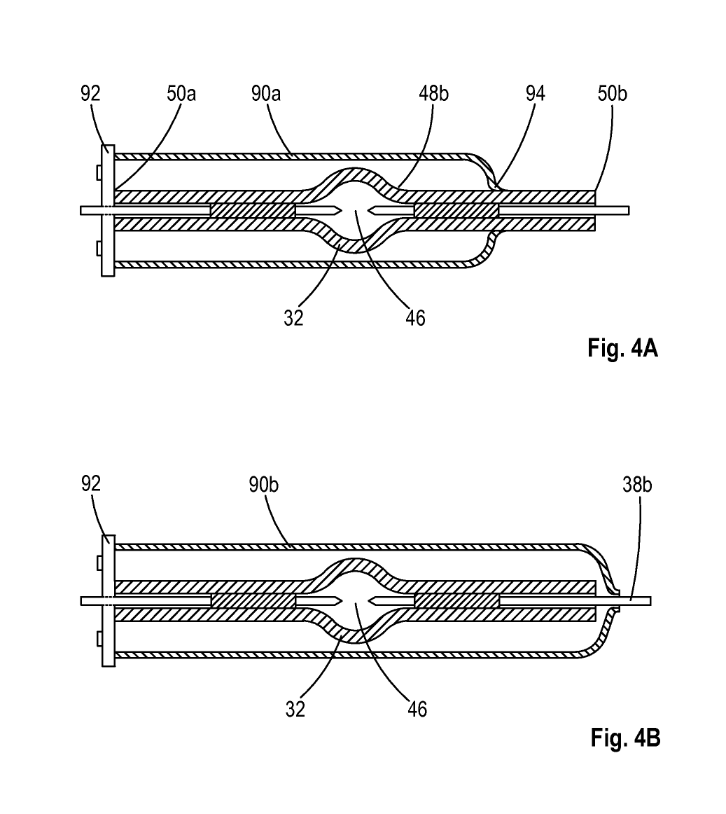

FIGS. 4A and 4B are the illustration of two additional forms of the chamber assembly, each having an envelop designated by 90a and 90b respectively. In FIG. 4A, there is a base mount seal 92 at one end 50a of the tube and a direct envelop-to-tube seal 94 anywhere from the neck-shaped portion 48b to the end 50b of the tube. In FIG. 4B, one end of the envelop 90b is sealed to the exposed portion of the conductor 38b instead of the tube wall.

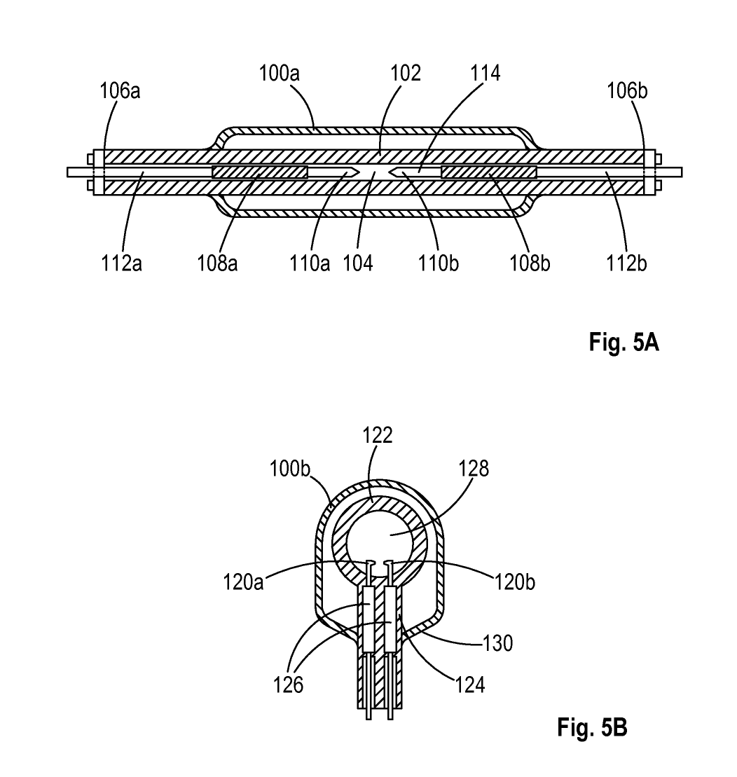

FIGS. 5A and 5B show another two forms of the chamber assembly, each having an envelop designated by 100a and 100b respectively. As shown in FIG. 5A, the inner chamber 102 has a cylindrical and tubular shape and is housed in the envelop 100a which also has a cylindrical shape. Enclosed inside the chamber 102 is the ionizable medium 104. The chamber 102 itself is sealed gas-tightly at the two ends 106a and 106b of the tubes adjoining the chamber. The gas-tight seals can be a valve seal or a face seal or an anchor seal. The seals can also comprise control valves that allow the ionizable medium to flow through the chamber. In this embodiment, members 108a and 108b, used to connect the electrodes 110a and 110b and the conductors 112a and 112b, are not sealed to the tubes' walls. In some embodiments, members 108a and 108b are not provided, whereas each electrode and the conductor are connected directly or simply, they are built together to one part. In some embodiments, a valve seal or a face seal or an anchor seal is provided at one end 106a of the tube, whereas the other side of the chamber is permanently sealed to the member 108b that has a close thermal expansion coefficient of the tube wall. Alternatively a graded glass seal may be applied to the seals made anywhere from the middle portion 114 of the electrode to the end of the conductor 112.

In FIG. 5B, a pair of electrodes 120a and 120b is positioned side by side in the chamber 122 which can, for example, have a spherical, an elliptical or an aspheric shape. A gas-tightly seal is provided at the tube wall section 124 and the metal foils 126 such as molybdenum foils. The ionizable medium 128 is enclosed in the chamber 122 which is entirely covered by the envelop 100b that can also have a spherical, an elliptical or an aspheric shape. In this embodiment, the envelop comprises a dome at the top and a cylindrical portion in the middle and a shrunk portion 130 at the lower section where the envelop is to be sealed to the tube adjoining the chamber 122.

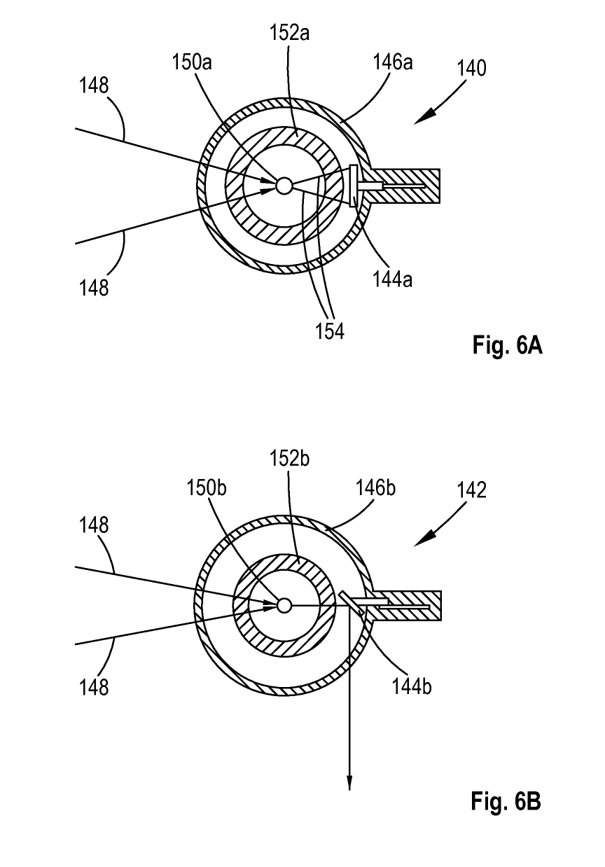

FIGS. 6A and 6B illustrate two enveloped-chamber assemblies 140 and 142, each having a laser-beam shield, designated by 144a and 144b, built in the inner space of the envelop 146a and 146b respectively. In FIG. 6A, the incident laser beam 148 is focused onto the plasma 150a enclosed in the chamber 152a. The unabsorbed portion 154 of the laser beam is reflected back into the chamber by the beam shield 144a. Thereby, the temperature of the plasma can be increased. In FIG. 6B, the beam shield 144b deflects the unabsorbed laser beam, passing through the chamber 152b and the plasma 150b, out of the chamber assembly 142. In some embodiments, the beam shields 144a and 144b are made to absorb laser energy. And, in some embodiments, the beam shields are made to absorb and reflect laser energy. Refractory materials such as tungsten, molybdenum, tantalum, nickel or rhenium can be used to build all theses beam shields that can have a concave, convex or flat shape with an even or uneven surface.

It is to be noted that for all the chamber assemblies presented in this invention, the seals which join together the envelop and the chamber can be either gas tight or not. And, as indicated in several embodiments discussed, the seals can be created anywhere from the end portion of the chamber to the end of the tubes adjoining the chamber or to the exposed portions of the conductors. Also, the space between the envelop and the enclosed chamber can be evacuated to create a vacuum inside or filled with air or any other gas such as Xe, Kr, Ar, Ne, He, N₂, O₂, CO₂, D₂ and H₂, or a mixture of more than one of gases at various pressures. Moreover, the ignition source can be one or more external ignition sources other than a pair of internal electrodes installed inside the chamber assembly.

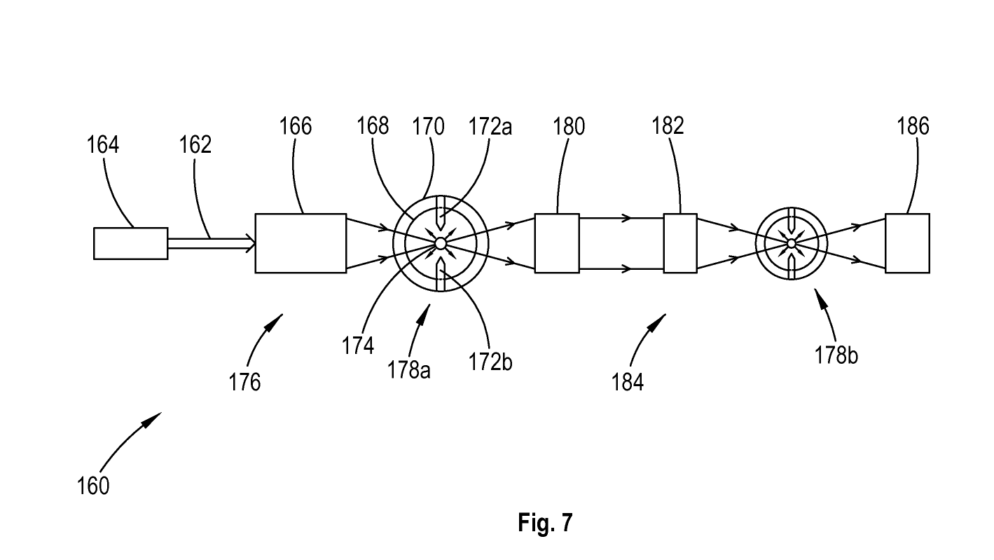

The following FIGS. 7, 8, 9 and 10 show a method for creating multiple light-emitting sources comprising more than one chamber assemblies and optical assemblies.

A diagram of the basic multiple light-emitting source configuration 160 is illustrated in FIG. 7 in which laser beam 162, generated by at least one laser source 164 including a pulse or continuous wave laser such as a diode laser, is sent to an optical assembly 166 through a set of optical elements (not shown) such as a laser light guide. The optical assembly 166, comprising optical elements such as convex and concave lenses and mirrors, expands, collimates, directs and focuses the laser beam onto the ionizable medium, for example high pressure Xe gas, enclosed in the chamber 168 that is covered with an envelop 170. After the ionizable medium is ignited with the high voltage on a pair of electrodes 172a and 172b, the desired plasma 174 will be developed at the focal point area within the chamber assembly. Emission light thus will be produced by the plasma that is sustained by the converged laser power. By way of this approach, the first light-emitting source 176 is formed. In some embodiments, there is only one light-emitting source that comprises the light-emitting source 176 as described herein.

The unabsorbed portion of the laser beam, passing through the first enveloped-chamber assembly 178a, then can be collimated, directed and focused into the second enveloped-chamber assembly 178b through the optical assemblies 180 and 182. The second enveloped-chamber assembly is similar to the first one and can be made smaller to be better compatible with the lower laser power. Similarly, emission light will be produced by the second plasma at the focal point area within the chamber assembly. As such, the second light-emitting source 184 is also formed.

The remaining laser beam, which is not absorbed by the second chamber assembly 178b, can be optionally re-focused to another chamber assembly in the same way. These steps can be repeated till the desired number of light-emitting sources is obtained. Lastly, the laser beam passing through all the chamber assemblies can be directed to an optional laser shield 186.

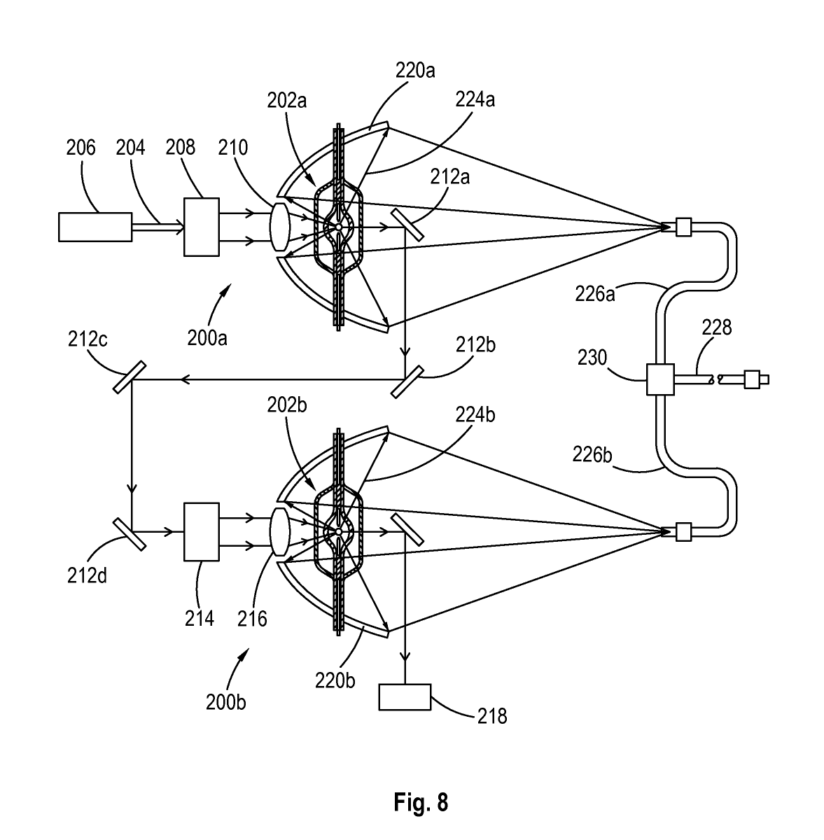

The light emissions produced from all the plasmas can be either utilized separately, or combined together to provide a brighter light output as will be shown in the following FIGS. 8, 9 and 10.

FIG. 8 shows a simplified system developed according to the method described in FIG. 7. The system comprises two light-emitting sources 200a and 200b, each having a chamber assembly designated by 202a and 202b respectively. The initial laser beam 204, generated by one or more laser sources 206, is expanded and collimated by the optical assembly 208 before it is focused onto the center area of the first chamber assembly 202a through a convex lens 210. A laser light guide (not shown) may be used to direct the laser beam to the optical assembly. The laser beam passing through the first chamber assembly is deflected toward the second chamber assembly 202b through a group of optical elements that for example can comprise reflectors 212a, 212b, 212c and 212d, collimator 214 and focusing lens 216. The collimator can have an optional beam expander incorporated into it. In this way, the light-emitting plasmas will be established and sustained at the center areas of the first and second chamber assemblies. The remaining laser beam traveling through the second chamber assembly is finally absorbed or scattered away by the beam shield 218, which for example can be made of one or more refractory metals such as tungsten, molybdenum, tantalum, rhenium and nickel, etc.

In the present embodiment, the focal points of the convex lens 210 and 216 are made to coincide with the first focal points of the curved reflectors 220a and 220b respectively as well as the centers of the chamber assemblies. The curved reflectors convert the emission light 224a and 224b to two focused beams onto the input ports of two optical fibers 226a and 226b respectively. The two optical fibers can be combined into one optical fiber 228 through a multi-mode or single-mode optical fiber coupler 230, or with a multi-branch optical fiber bundle. Sources for the fiber coupler and the multi-branch fiber include Newport Corporation, Irvine, Calif. By way of this approach, higher-brightness light can be obtained at the output port of the fiber 228.

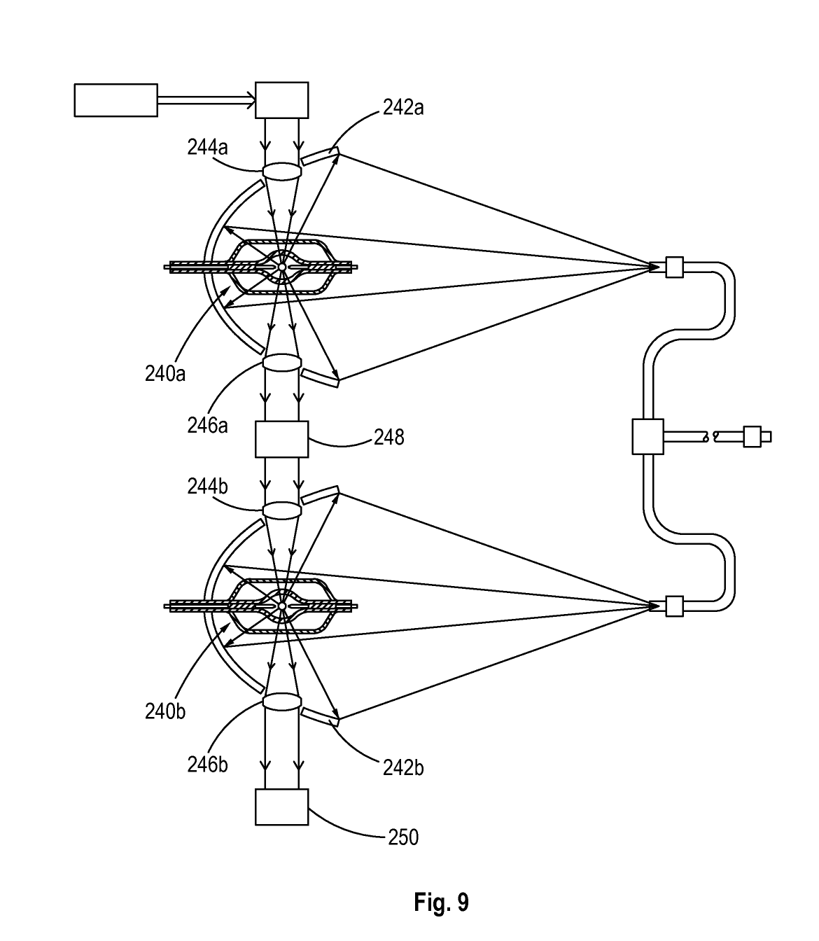

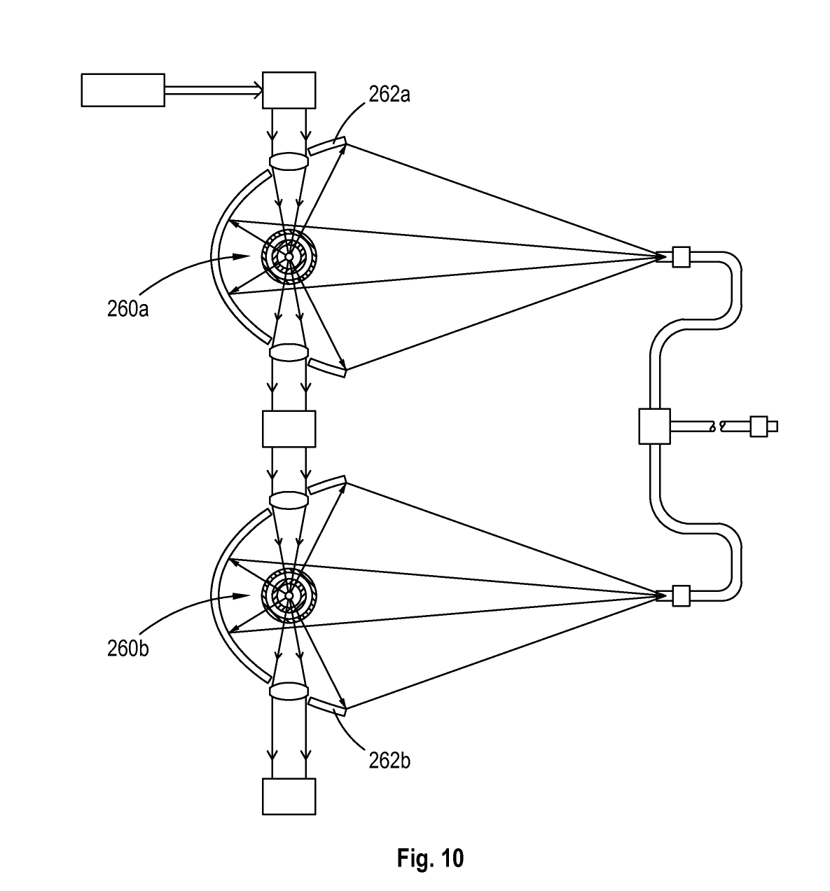

FIG. 9 is the illustration of an alternate system similar to the one shown in FIG. 8. The foregoing descriptions for FIG. 8 can be applied to this configuration basically and for convenience, most of the same numerals are omitted. The distinction for this system is in the laser beam path as shown and the orientation of chamber assemblies 240a and 240b which in this configuration are arranged alongside the longitudinal axes of the curved reflector 242a and 242b, respectively. Also in this embodiment, there are two holes made on each curved reflector with one hole incorporating a focusing convex lens 244a and 244b and the other incorporating an optional collimating convex lens 246a and 246b. Between the two curved reflectors, there is an optional collimator 248 placed in the laser path to re-shape the beam as needed. The initial laser beam passes through the first and the second chamber assemblies in sequence to supply energy to the two plasmas that produce light emissions. The final unabsorbed laser beam can be absorbed or scattered away by the shield 250.

FIG. 10 is the illustration of another system similar to those shown in FIGS. 8 and 9. The descriptions for FIGS. 8 and 9 can be applied to this configuration basically, and for convenience, most of the same numerals are also omitted. In this embodiment, the chamber assemblies 260a and 260b are disposed along the direction perpendicular to the longitudinal axes of the curved reflectors 262a and 262b.

Regarding the configurations in FIGS. 8, 9 and 10, in some embodiments, separate fibers coupled to the emission light beams are not combined into one fiber. In some embodiments, the multiple light-emitting sources are offered without coupling the emission light to fiber optics. In some other embodiments, the curved reflectors 220a and 220b convert the emission light into collimated or diverged (spread out) light beams, instead of focused light beams, for output without fiber optics incorporated.

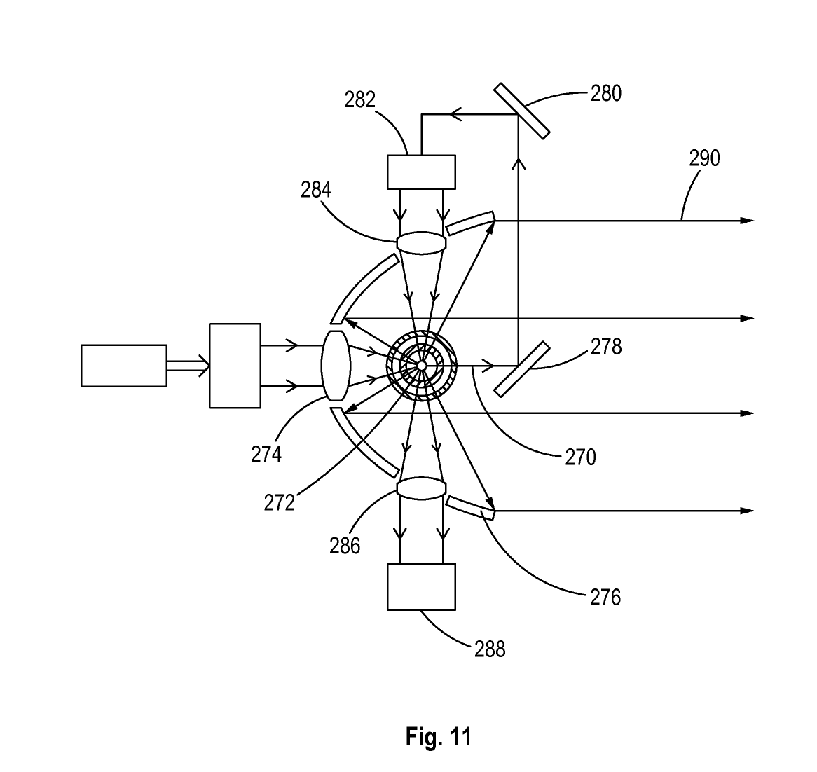

FIG. 11 illustrates a method for re-focusing the unabsorbed laser beam back to the same plasma inside the chamber, so as to improve laser usage efficiency. In this method, the laser beam 270 passing through the chamber assembly is re-focused back to the same plasma 272 located at the focal point of the convex lens 274 and the curved reflector 276. A set of optical elements, such as the reflectors 278 and 280 in this embodiment, are used to direct the laser beam 270 onto the collimator 282 that can have an optional beam expander incorporated into it. The collimated beam then is re-focused back onto the plasma through the convex lens 284. Finally, the unabsorbed laser beam will be re-shaped by an optional lens 286 and directed to the beam shield 288 or to the next light-emitting source (not shown) to form a multiple-source system. In the meantime, the emission light produced by the plasma is converted to a collimated beam 290, or a focused beam (not shown) by the curved reflector 276 for output. By this method, enhanced light emission can be achieved with the same laser source.

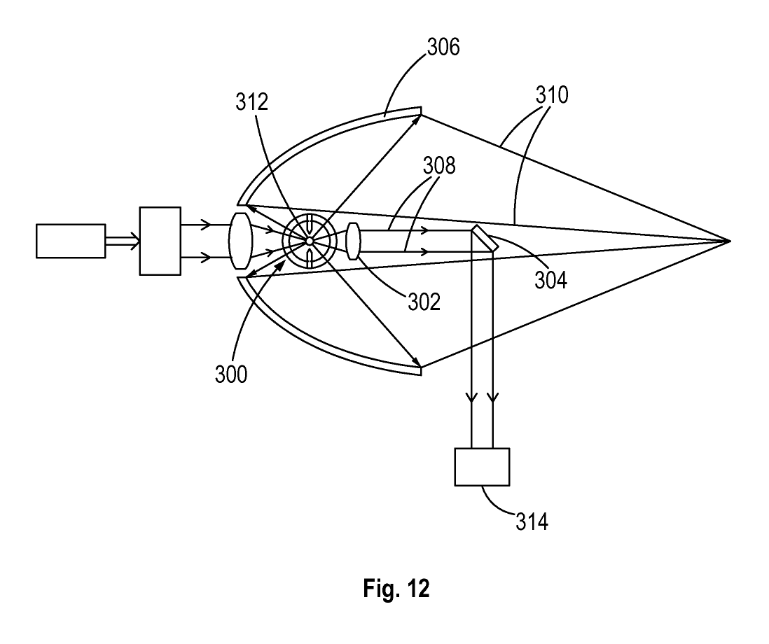

FIG. 12 illustrates a method that further improves the laser usage efficiency. In addition to an enveloped-chamber assembly 300 used, a beam-shrinking optical element 302 such as a convex lens is placed between the chamber assembly 300 and the beam deflector 304 and on the longitudinal axis of the curved reflector 306. As shown in the figure, the laser beam 308, passing through the chamber assembly and the optical element 302, will have a narrower beam size and a reduced irradiating area onto the beam deflector 304, compared with the case without the presence of the beam-shrinking element. Thereby, a smaller beam deflector 304 can be used and placed further away from the chamber assembly without blockage of the emission light 310. The distant beam deflector allows a larger curved reflector 306 used to collect and convert more emission light from the plasma 312 to a focused output beam as shown in the figure or to a collimated output beam (not shown). The laser beam deflected out of the curved reflector can be directed to a shield 314 or to the next light-emitting source (not shown) to form a multiple-source system as discussed before.

It is to be understood that in FIGS. 7, 8, 9, 10, 11, 12, the chamber assemblies can either have an envelop or not, and the output light beams can be focused or collimated or simply diverged. Also, the discussed configurations can be combined together to form a high-efficiency light source system. For instance, a single or a multiple-source system can comprise one or more sub-assemblies respectively, each having the unabsorbed laser beam refocused back to the plasma as shown in FIG. 11 or having a reduced-size beam deflector as shown in FIG. 12 or, or having both features shown in FIGS. 11 and 12. Another example is a device similar to that shown in FIG. 11 but with a beam-shrinking element placed between the chamber assembly and the reflector 278 in a similar way as described for FIG. 12. Further, an optional light-transmitting window can be mounted on the front open aperture of the curved reflector. Finally, the foregoing configurations are presented for the illustration of the invented methods, and thus for convenience, do not include the information on the various surrounding components such as the mounting accessories, fittings, connections, housing, temperature monitoring and control unit, laser and emission light control circuitries and more.

The present invention now has been described in detail in accordance with the requirements of the patent statutes. Those skilled in this art will have no difficulty in making changes and modifications in the individual parts or the relative assemblies without departing from the scope and spirit of the invention, as set forth in the following claims.

What is claimed is:

1. A light source comprising:
a) a chamber assembly comprising a chamber enclosed in an envelop;
b) an ionizable medium enclosed in said chamber for emitting light when excited; and
c) at least one laser source that provides energy to the excited said medium for producing emission light.

2. The light source as defined in claim 1 wherein each of said chamber and said envelop comprises at least one of the materials of quartz, fused quartz, ozone free quartz, synthetic quartz, single crystal quartz, UV blocking quartz, UV transmitting quartz, Suprasil quartz, fused silica, Suprasil fused silica, glass, alumina ceramic, sapphire, diamond, MgF₂, and CaF₂.

3. The light source as defined in claim 1 wherein the space between said chamber and said envelop is evacuated to create a vacuum in the space.

4. The light source as defined in claim 1 wherein the space between said chamber and said envelop is filled with at least one of the gases of air, Xe, Kr, Ar, Ne, He, N₂, O₂, CO₂, D₂ and H₂.

5. The light source as defined in claim 1 wherein at least one of said chamber and said envelop comprises a coating that transmits and reflects selective radiation.

6. The light source as defined in claim 1 wherein said chamber assembly further comprises a light beam shield disposed between said chamber and said envelop.

7. The light source as defined in claim 1 further comprising at least one ignition source for exciting said medium.

8. The light source as defined in claim 7 wherein said ignition source comprises electrodes disposed apart from each other.

9. The light source as defined in claim 1 further comprising means for removing the deposit on the walls of said chamber for allowing the laser beam, generated by said laser source, to travel into said chamber without being obstructed by the deposit.

10. A method for providing multiple light emitting sources comprising:
a) more than one chamber assemblies, each comprising a chamber enclosing an ionizable medium;
b) at least one laser source that provides energy to each excited said medium for producing emission light; and
c) directing and focusing the laser beam, generated by said laser source, onto each excited said medium in sequence through a group of optical elements.

11. The method as defined in claim 10 wherein each of said chamber assemblies further comprises an envelop that encloses said chamber.

12. The method as defined in claim 10 further comprising a curved reflector for each of said chamber assemblies to convert the emission light from each excited said medium to a focused light beam.

13. The method as defined in claim 12 further comprising multiple optical fibers coupled to the focused emission light beams.

14. The method as defined in claim 13 wherein said multiple optical fibers are combined into one optical fiber for final light output.

15. The method as defined in claim 10 further comprising a curved reflector for each of said chamber assemblies to convert the emission light from each excited said medium to a collimated beam.

16. The method as defined in claim 10 further comprising at least one ignition source for each of said chamber assemblies to excite each said medium.

17. A method for producing light comprising:
a) a chamber assembly comprising a chamber enclosing an ionizable medium;
b) at least one laser source that provides energy to the excited said medium for producing emission light; and
c) directing and focusing the laser beam, generated by said laser source, onto the excited said medium and refocusing the unabsorbed laser beam back to the same excited said medium through a group of optical elements.

18. The method as defined in claim 17 wherein said chamber assembly further comprises an envelop that encloses said chamber.

19. The method as defined in claim 17 further comprising a curved reflector to convert the emission light from the excited said medium to a collimated beam.

20. The method as defined in claim 17 further comprising a curved reflector to convert the emission light from the excited said medium to a focused beam.

21. The method as defined in claim 17 further comprising at least one ignition source for exciting said medium.
